(19) United States
(12) Patent Application Publication
(10) Pub. No.: US 2025/0232926 A1
(43) Pub. Date: Jul. 17, 2025

(54) CERAMIC CAPACITOR AND MANUFACTURING METHOD THEREFOR

(71) Applicant: AMOTECH CO., LTD., Incheon (KR)

(72) Inventors: Byungguk LIM, Incheon (KR); Yunsuk CHOI, Incheon (KR); Jaeyong SONG, Incheon (KR)

(73) Assignee: AMOTECH CO., LTD., Incheon (KR)

(21) Appl. No.: 18/730,726

(22) PCT Filed: Dec. 8, 2022
(86) PCT No.: PCT/KR2022/019875

§ 371 Date: Jul. 19, 2024

(30) Foreign Application Priority Data
Jan. 19, 2022 (KR) 10-2022-0007816

(51) Int. Cl. H01G 13/00; H01G 2/06; H01G 4/012; H01G 4/12; H01G 4/232; H01G 4/30

(52) U.S. Cl. CPC H01G 13/00; H01G 2/065; H01G 4/012; H01G 4/12; H01G 4/232; H01G 4/30

(57) ABSTRACT

The present invention relates to a ceramic capacitor and a manufacturing method therefor, the ceramic capacitor comprising: a ceramic body which is formed in a hexahedron shape, includes a plurality of dielectric layers and at least one pair of internal electrodes disposed to face each other with the dielectric layers therebetween, and includes two end surfaces through which the internal electrodes are exposed, a lower surface which is a mounting surface mounted on a substrate, an upper surface facing the lower surface, and a front surface and a rear surface connecting the upper surface and the lower surface together and facing each other; and external electrodes respectively disposed on the end surfaces of the ceramic body so as to be electrically connected to the internal electrodes, wherein the external electrodes include: a metal layer formed on the entire end surfaces of the ceramic body so as to be connected to the internal electrodes; and a conductive resin layer formed on both edges of the end surfaces of the ceramic body.

### TECHNICAL FIELD

The present disclosure relates to a ceramic capacitor and a method for manufacturing the same, and more particularly, to a ceramic capacitor and a method for manufacturing the same, in which shock absorption efficiency is improved, and an external electrode having low electrical resistance is applied thereto.

### BACKGROUND ART

A capacitor is used for the purpose of protecting a component in which a voltage should be kept constant by storing electricity therein and by uniformly and stably supplying the stored electricity to the component as much as the component needs, for the purpose of removing a noise in an electronic device, or for the purpose of passing only an AC signal from signals where DC and AC are mixed.

In general, a ceramic capacitor is composed of dielectrics, internal electrodes, and external electrodes. In the ceramic capacitor, since electric charge is accumulated between the internal electrodes facing each other, miniaturization and high capacity are implemented through stacking of many layers of internal electrodes in a limited space. The capacitor may cause cracks to easily occur at a corner part under high stress due to a difference in thermal expansion coefficient when being mounted on the substrate. The ceramic capacitor has the characteristic that is changed even due to fine cracks, and if two terminals are shorted by the cracks, the ceramic capacitor is unable to operate, and thus there is a problem in that the reliability is decreased.

The matters described in the above background technology are to help understanding of the background of the present disclosure, and may include the matters that are not the disclosed related art.

### SUMMARY OF INVENTION

### Technical Problem

An object of the present disclosure is to provide a ceramic capacitor and a method for manufacturing the same, in which cracks are prevented from occurring by improving the shock absorption efficiency through applying of a conductive resin layer to an external electrode, an ESR is improved by lowering the electrical resistance through improvement of the structure of the ceramic capacitor, and the connection reliability to the substrate is improved.

### Solution to Problem

In order to achieve the above object, a ceramic capacitor according to an embodiment of the present disclosure includes: a ceramic body formed in a hexahedron shape, including a plurality of dielectric layers and at least a pair of internal electrodes disposed to face each other with the dielectric layers interposed therebetween, and including both end surfaces from which the internal electrodes are exposed, a lower surface that is a mount surface mounted on a substrate, an upper surface facing the lower surface, and a front surface and a rear surface connecting the upper surface and the lower surface together and facing each other; and external electrodes disposed on the both end surfaces of the ceramic body so as to be electrically connected to the internal electrodes, wherein the external electrode includes: a metal layer formed throughout the end surfaces of the ceramic body so as to be connected to the internal electrode; and a conductive resin layer formed at both-side corners of the end surfaces of the ceramic body.

The metal layer is formed to extend from the end surfaces of the ceramic body to the upper and lower surfaces and the front and rear surfaces of the ceramic body.

The metal layer has a center part between the both-side corners on the end surfaces of the ceramic body, which is exposed without being covered by the conductive resin layer.

The conductive resin layer is formed on the metal layer.

The conductive resin layer may be in a shape that covers the entire top and bottom of the both-side corners of the end surfaces of the ceramic body.

The conductive resin layer may be in a shape that covers up to some areas of the upper surface and the lower surface connected to the respective corners.

The external electrode may further include a plating layer.

The plating layer may come in direct contact with the metal layer all over the top and bottom on the end surfaces of the ceramic body.

The plating layer is in a shape that completely covers the conductive resin layer.

The plating layer may include a first area that comes in contact with the conductive resin layer and a second area that comes in contact with the metal layer on the upper and lower surfaces and the front and rear surfaces of the ceramic body.

The plating layer may be formed on the conductive resin layer and the metal layer on the upper and lower surfaces and the front and rear surfaces of the ceramic body, and may expose a part of the metal layer to outside.

The plating layer may include a first area that comes in contact with the conductive resin layer, a second area that comes in contact with the metal layer, and a third area that comes in contact with the ceramic body on the upper and lower surfaces and the front and rear surfaces of the ceramic body.

The plating layer may have a one-layer structure of a Ni plating layer or a two-layer structure of a Ni plating layer and a Sn plating layer.

The metal layer may include Cu, and the conductive resin layer may be made of Ag epoxy resin.

A method for manufacturing a ceramic capacitor includes: a step of forming a ceramic body provided with front and rear surfaces facing each other, upper and lower surfaces facing each other, and both end surfaces facing each other, and exposing internal electrodes onto the both end surfaces; a step of forming a metal layer on the entire both end surfaces of the ceramic body so as to be connected to the internal electrodes; and a step of forming a conductive resin layer at both-side corners of the both end surfaces of the ceramic body.

The step of forming the metal layer may form the metal layer by applying a paste including a conductive metal or dipping and sintering in a dipping solution including the conductive metal onto the both end surfaces of the ceramic body and from the both end surfaces to a portion of the upper and lower surfaces and a portion of the front and rear surfaces.

The step of forming the conductive resin layer

may form the conductive resin layer that covers respective corners of the ceramic body and some areas of the upper surface and the lower surface connected to the corners by dipping the corners of the ceramic body on which the metal layer is formed in Ag epoxy resin solution.

The method may further include a step of forming a plating layer which comes in direct contact with the metal layer over the entire top and bottom on the both end surfaces of the ceramic body and which completely covers the conductive resin layer after the step of forming the conductive resin layer.

### Advantageous Effects of Invention

The present disclosure has the effects of preventing cracks from occurring even if the corner part is under a lot of stress due to the difference in thermal expansion coefficient when the ceramic body is mounted on the substrate since the conductive resin layer is formed all over the top and bottom of the corner areas of the ceramic body that experience the most stress, and thus the shock absorption function is provided.

Further, the present disclosure has the effects of improving the ESR through shortening of the current path and reduction of the electrical resistance since the plating layer comes in direct contact with the metal layer all over the top and bottom of the corner areas of the ceramic body.

Further, the present disclosure can secure the maximum effects of crack occurrence prevention while preventing the problems in that the electrical connection becomes inferior due to the conductive resin layer or the strength of the external electrode is decreased since the conductive resin layer is formed on the metal layer and does not come in direct contact with the ceramic body.

### BRIEF DESCRIPTION OF DRAWINGS

FIG. 1 is a perspective view showing a ceramic capacitor according to a first embodiment of the present disclosure.

FIG. 2 is a cross-sectional view taken along line A-A of FIG. 1.

FIG. 3 is a perspective view showing a ceramic capacitor according to an embodiment of the present disclosure in which plating layers are further included in external electrodes.

FIG. 4 is a cross-sectional view taken along line B-B of FIG. 3.

FIG. 5 is a cross-sectional view showing the shape of a plating layer according to another embodiment of the present disclosure.

FIG. 6 is a perspective view showing the shape in which a ceramic capacitor according to an embodiment of the present disclosure is seated on a substrate and is soldered.

FIG. 7 is a cross-sectional view taken along line C-C of FIG. 6, and FIG. 8 is a cross-sectional view taken along line D-D of FIG. 6.

FIG. 9 is a cross-sectional view of another embodiment corresponding to the cross section taken along line D-D of FIG. 6.

FIG. 10 is a processing diagram showing a method for manufacturing a ceramic capacitor according to an embodiment of the present disclosure.

FIG. 11 is a constitution diagram showing a method for forming a conductive resin layer in a method for manufacturing a ceramic capacitor according to an embodiment of the present disclosure.

### DESCRIPTION OF EMBODIMENTS

Hereinafter, preferred embodiments of the present disclosure will be described in detail with reference to the accompanying drawings.

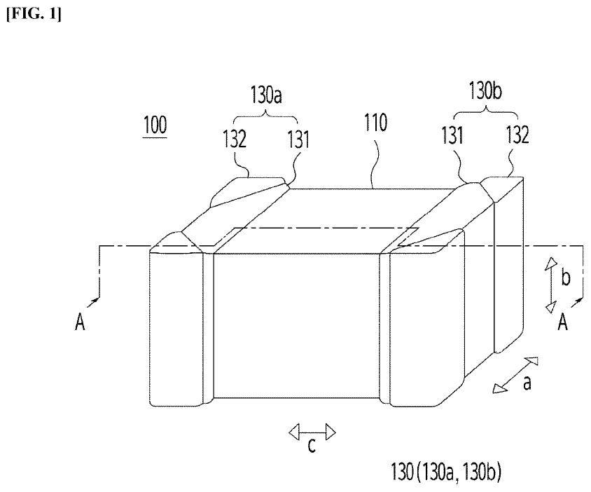

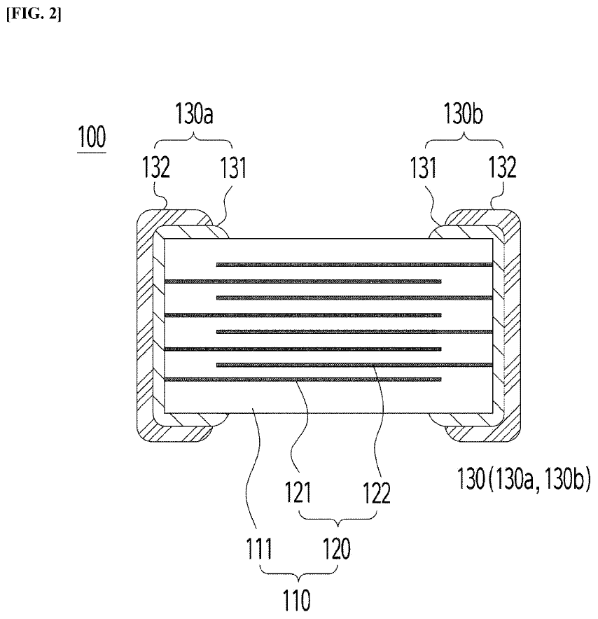

FIG. 1 is a perspective view showing a ceramic capacitor according to a first embodiment of the present disclosure, and FIG. 2 is a cross-sectional view taken along line A-A of FIG. 1. In the drawings of the present disclosure, thicknesses of internal electrodes, thicknesses of external electrodes, and sizes thereof are exaggerated in order to emphasize the features of the present disclosure, and thus the present disclosure is not limited to the thicknesses and sizes of the electrodes illustrated in the drawings.

As illustrated in FIGS. 1 and 2, a ceramic capacitor 100 according to the present disclosure includes a ceramic body 110, an internal electrode 120, and an external electrode 130.

The ceramic body 110 includes a plurality of dielectric layers 111 laminated up and down and at least a pair of internal electrodes 120 disposed to face each other with the dielectric layers 111 interposed therebetween. The exterior of the ceramic body 110 is roughly hexahedral in shape, and includes both end surfaces from which the internal electrodes 120 are exposed, a lower surface that is a mount surface mounted on a substrate, an upper surface facing the lower surface, and a front surface and a rear surface connecting the upper surface and the lower surface together and facing each other.

In the ceramic body 110, two surfaces facing in direction a are the front surface and the rear surface, two surfaces facing in direction bare the upper surface and the lower surface, and two surfaces facing in direction c are the both end surfaces.

The ceramic body 110 is formed by vertically laminating and sintering the plurality of dielectric layers 111. The plurality of dielectric layers 111 are in a sintered state, and the boundaries between the adjacent dielectric layers may be unified to the extent that it is difficult to confirm.

The material of the dielectric layer 111 may be a barium titanate (BaTiO₃)-based ceramic having high permittivity. In addition, the material that forms the dielectric layer 111 may use or additionally include (Ca, Zr) (Sr, Ti)O₃-based ceramic. However, since the capacitance is in proportion to the permittivity of the dielectric, it is preferable to use the dielectric material BaTiO₃ having high permittivity.

The internal electrode 120 includes a first internal electrode 121 and a second internal electrode 122. The first internal electrode 121 is exposed to one of both end surfaces of the ceramic body 110, and the second internal electrode 122 is exposed to the other end surface that faces the one end surface of the ceramic body 110. The first internal electrode 121 and the second internal electrode 122 include an overlapping part. The first internal electrode 121 and the second internal electrode 122 form capacitance on the overlapping part.

At least one layer of the first internal electrode 121 and the second internal electrode 122 is disposed inside the ceramic body 110. As an example, three layers or more of first internal electrodes 121 and second internal electrodes 122 may be disposed inside the ceramic body 110, and in order to increase the capacitance, several tens or several hundreds of layers may be disposed. The internal electrode 120 may be formed by printing an internal electrode material on an upper surface of the dielectric layer 111.

The material of the internal electrode 120 may be one of Cu, Ni, and Pd—Ag or an alloy thereof. During a sintering process that is performed at high temperature, Pd, which is an expensive precious metal, may be used as the internal electrode in order to inhibit oxidation of the internal electrode, but for cost reduction in accordance with the demand for miniaturization and high capacity of the MLCC, one of Pd—Ag, Ni, and Cu or an alloy thereof may be used as the internal electrode.

The external electrodes 130 are disposed on both end surfaces of the ceramic body 110 so as to be electrically connected to the internal electrodes 120. The external electrode 130 includes a first external electrode 130a and a second external electrode 130b. The first external electrode 130a is disposed on one end surface of the ceramic body 110, and is electrically connected to the first internal electrode 121. The second external electrode 130b is disposed on the other end surface of the ceramic body 110, and is electrically connected to the second internal electrode 122.

The first and second external electrodes 131 and 132 include the metal layer 131 and the conductive resin layer 132.

The metal layer 131 is formed on both end surfaces of the ceramic body 110 so as to be connected to the first and second internal electrodes 121 and 122. Further, the metal layer 131 may be formed on both end surfaces of the ceramic body 110, and may be formed to extend from the both end surfaces to a part of the upper and lower surfaces and a part of the front and rear surfaces. In case that the metal layer 131 is shaped to extend from the both end surfaces of the ceramic body 110 to the part of the upper and lower surfaces and the part of the front and rear surfaces, the tensile strength of the ceramic body 110 is increased, and thus the crack occurrence is reduced.

The metal layer 131 may be a sintered metal layer. As an example, the metal layer 131 can be formed by applying a paste including a conductive metal or dipping and sintering in a dipping solution including the conductive metal onto the both end surfaces of the ceramic body 110 and from the both end surfaces to the portion of the upper and lower surfaces and the portion of the front and rear surfaces. The metal layer 131 may be formed of Cu having high electrical conductivity.

In case that the metal layer 131 is shaped to extend from the both end surfaces of the ceramic body 110 to the part of the upper and lower surfaces and the part of the front and rear surfaces, the extended length of the metal layer 131 is maximally extendable within a range where parasitic capacitance does not occur with the internal electrode 120. As an example, it is preferable that a distance between the metal layer 131 of the first external electrode 130a that is spaced apart from the front surface and the rear surface of the ceramic body 110 and the metal layer 131 of the second external electrode 130b is relatively longer than the length of the metal layer 131 extending from the both end surfaces of the ceramic body 110 to the part of the front and rear surfaces. Further, the distance between the metal layer 131 of the first external electrode 130a that is spaced apart from the front surface and the rear surface of the ceramic body 110 and the metal layer 131 of the second external electrode 130b may correspond to the length of the part where the first internal electrode 121 and the second internal electrode 122 overlap each other.

The conductive resin layer 132 serves as a shock absorption layer against an external stress by giving ductility to the external electrode 130 located at four corners of the ceramic body, and has a crack prevention effect by dispersing the stress.

The conductive resin layer 132 is formed at both-side corners of the ceramic body 110. More specifically, the conductive resin layer 132 is formed in the shape that covers the both-side corners of the both end surfaces of the ceramic body 110, and prevents cracks at the corner part where the stress is concentrated.

The conductive resin layer 132 is formed only on the metal layer 131. Further, the conductive resin layer 132 does not come in direct contact with the ceramic body 110. As an example, the metal layer 131 is formed on both end surfaces of the ceramic body 110, and is formed to extend from the both end surfaces to the parts of the upper and lower surfaces and the front and rear surfaces, and the conductive resin layer 132 is formed only on the metal layer 131 at four corner parts of the ceramic body 110, and does not come in direct contact with the ceramic body 110.

In case that the conductive resin layer 132 comes in direct contact with the ceramic body 110, the area of the metal layer 131 is relatively decreased, and there may be a problem in that the electrical connection between the substrate and the internal electrode 120 becomes bad. Further, in case that the conductive resin layer 132 comes in direct contact with the ceramic body 110, the area of the plating layer that covers the conductive resin layer 132 for moisture resistance should be additionally formed, and thus the parasitic capacitance occurs between the plating layer and the internal electrode, and an accurate capacitance design may be difficult.

Further, the conductive resin layer 132 is formed up and down at four corners of the ceramic body 110, and is formed to cover some areas of the upper surface and the lower surface connected to the corners. If the conductive resin layer 132 is formed to cover the respective corners and some areas of the upper surface and the lower surface of the corners of the ceramic body 110, the four corner parts of the ceramic body 110 are stably covered, and thus even if the corner parts are under a lot of stress due to the difference in thermal expansion coefficient when being mounted on the substrate, uniform distribution of the stress is possible, and thus the cracks can be prevented from occurring.

The conductive resin layer 132 may be made of a resin including Ag, and preferably, it may be made of Ag epoxy. The Ag epoxy is obtained by uniformly mixing Ag powder having high electrical conductivity with the epoxy resin. The conductive resin layer 132 may be formed by dipping the corners of the ceramic body 110 on which the metal layer 131 is formed in Ag epoxy resin solution. The conductive resin layer 132 may be formed in a shape in which the thickness of the corner part is thickest, and the thickness becomes thinner toward the edges.

In an embodiment, the metal layer 131 has a center part between the both-side corners on the end surfaces of the ceramic body 110, which is exposed to outside without being covered by the conductive resin layer 132. The external electrode 130 may further include a plating layer 133 that covers the metal layer 131.

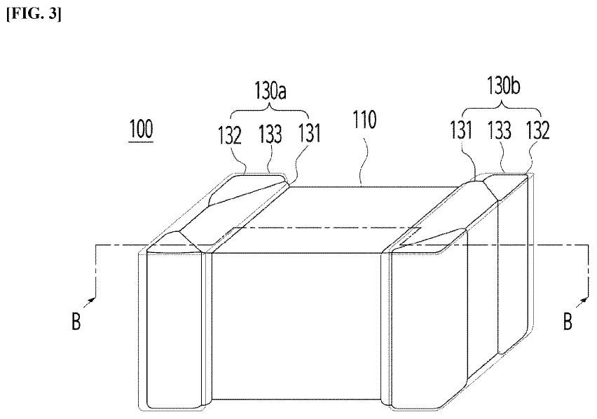

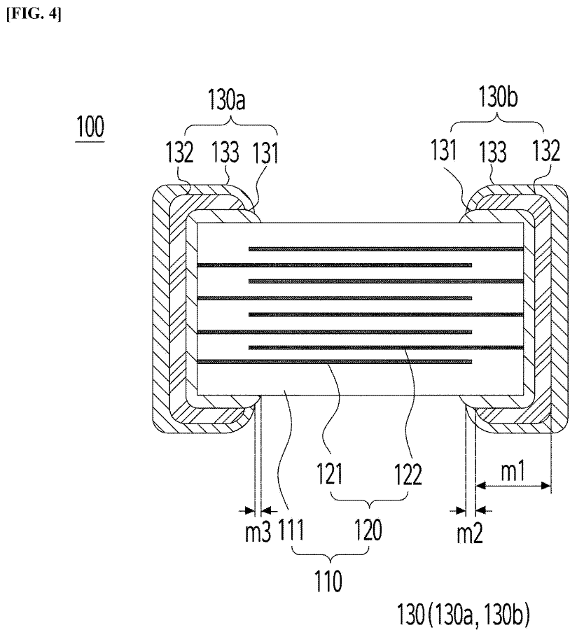

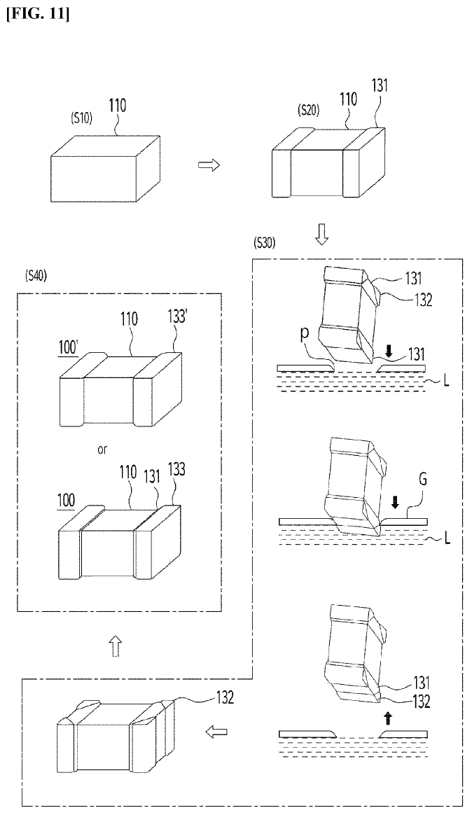

FIG. 3 is a perspective view showing a ceramic capacitor according to an embodiment of the present disclosure in which plating layers are further included in external electrodes, and FIG. 4 is a cross-sectional view taken along line B-B of FIG. 3. For convenience in explanation, the plating layer is marked with a thin line in FIG. 3, and the exterior of the ceramic capacitor in which the plating layer is formed can be confirmed in FIG. 11.

As illustrated in FIGS. 3 and 4, the external electrode 130 further includes the plating layer 133. The plating layer 133 is to increase adhesion to the substrate and to improve the moisture resistance.

The plating layer 133 is formed to cover the metal layer 131 and the conductive resin layer 132.

The plating layer 133 comes in direct contact with the metal layer 131 all over the top and bottom on the both end surfaces of the ceramic body 110. Since the plating layer 133 comes in direct contact with the metal layer 131, the current path is shortened, the resistance is reduced, and thus there is an effect of reducing the ESR.

The plating layer 133 is in a shape that completely covers the conductive resin layer 132. If the conductive resin layer 132 is exposed to the outside, internal moisture problem may occur, and adhesion to the substrate may be decreased. Accordingly, by forming the plating layer 133 to completely cover the conductive resin layer 132, the adhesion to the substrate is increased, and the electrical connection between the circuit pattern of the substrate and the internal electrode is stably made. Further, the conductive resin layer 132 has a weak current flow as compared with the metal layer 131, and by making the current flow well through the plating layer 133, the resistance is reduced, and the electrical connection is stably made.

The plating layer 133 may expose a part of the metal layer 131 from the upper and lower surfaces and the front and rear surfaces of the ceramic body 110. This is to solve the conductivity problem and the internal moisture problem by forming the plating layer 133 so as to completely cover the conductive resin layer 132 that is exposed to the upper and lower surfaces and the front and rear surfaces of the ceramic body 110, and by making the exposed metal layer 131 come in direct contact with the solder, the current moves to the internal electrode 120 through the exposed metal layer 131, and thus the effect of making the current path shortened can be sought. In this case, the plating layer 133 may include a first area m1 that comes in contact with the conductive resin layer 132 and a second area m2 that comes in contact with the metal layer 131 on the upper and lower surfaces and the front and rear surfaces of the ceramic body 110. In this case, the plating layer 133 does not come in direct contact with the

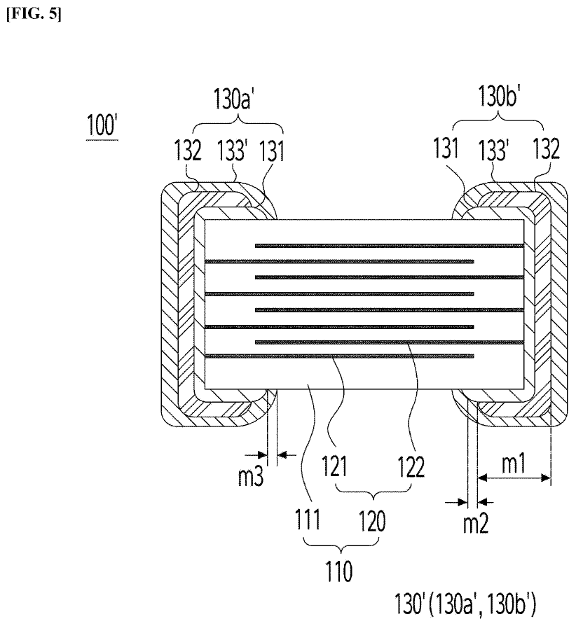

FIG. 5 is a cross-sectional view showing the shape of a plating layer according to another embodiment of the present disclosure.

As illustrated in FIG. 5, as another embodiment, the plating layer 133′ may not expose the metal layer 131 on the upper and lower surfaces and the front and rear surfaces of the ceramic body 110. The plating layer 133′ is formed to completely cover the conductive resin layer 132 that is exposed to the upper and lower surfaces and the front and rear surfaces of the ceramic body 110 and the metal layer 131, and thus the conductivity problem and the internal moisture problem can be solved. In this case, the plating layer 133′ may include a first area m1 that comes in contact with the conductive resin layer 132, a second area m2 that comes in contact with the metal layer 131, and a third area m3 that comes in contact with the ceramic body 110 on the upper and lower surfaces and the front and rear surfaces of the ceramic body 110.

As in the former case, in case that the plating layer 133 completely covers the conductive resin layer 132 and a part of the metal layer 131 is exposed, it may be effective in improving the ESR by shortening the current path and lowering the electrical resistance, whereas as in the latter case, in case that the plating layer 133′ completely covers the conductive resin layer 132 and the metal layer 131, the ESR is somewhat decreased as compared with the former case, but it may be effective in solving the internal moisture problem.

The plating layer 133 may include a Ni layer and a Sn layer formed to cover the Ni layer. The plating layer 133 may be formed by dipping in a plating solution or may be formed in an electroplating process.

In case of the embodiment illustrated in FIG. 4, the external electrode 130 has a four-layer structure of Cu layer, Ag epoxy layer, Ni layer, and Sn layer in the first area m1, and has a three-layer structure of Cu layer, Ag epoxy layer, Ni layer, and Sn layer in the second area m2, and has a one-layer structure of Cu layer in the third area m3.

In case of another embodiment illustrated in FIG. 5, the external electrode 130′ has a four-layer structure of Cu layer, Ag epoxy layer, Ni layer, and Sn layer in the first area m1, and has a three-layer structure of Cu layer, Ag epoxy layer, Ni layer, and Sn layer in the second area m2, and has a three-layer structure of Cu layer, Ni layer, and Sn layer in the third area m3.

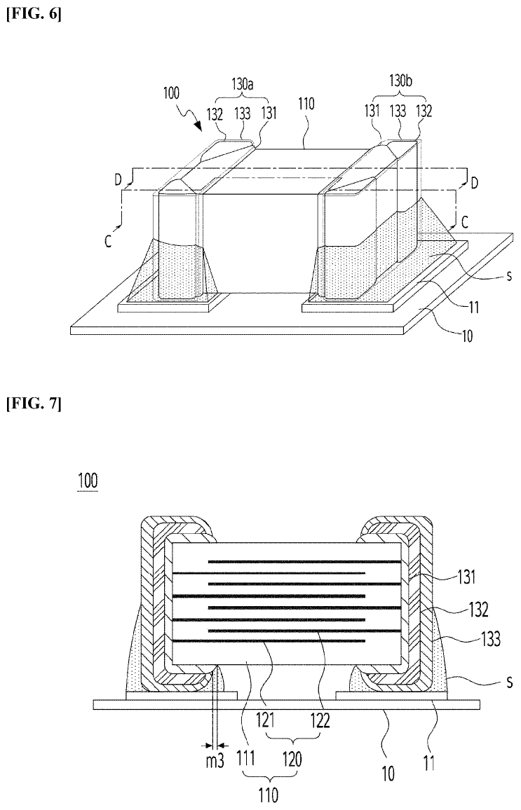

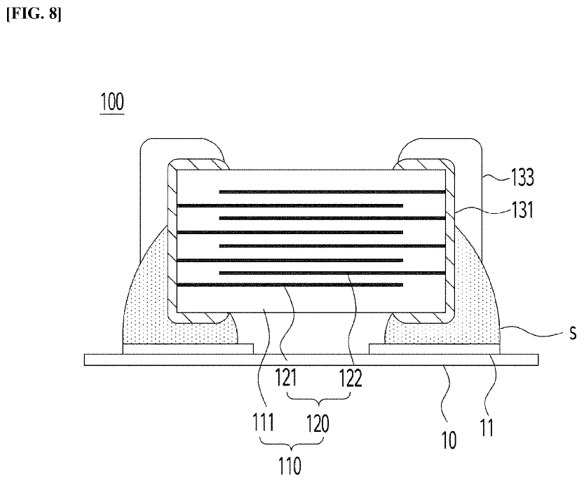

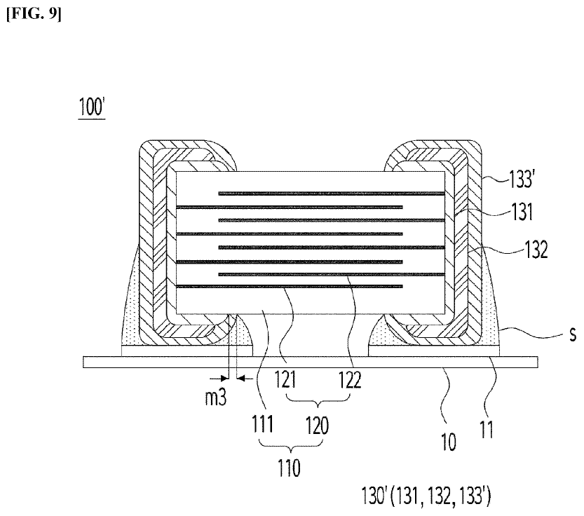

FIG. 6 is a perspective view showing the shape in which a ceramic capacitor according to an embodiment of the present disclosure is seated on a substrate and is soldered, FIG. 7 is a cross-sectional view taken along line C-C of FIG. 6, FIG. 8 is a cross-sectional view taken along line D-D of FIG. 6, and FIG. 9 is a cross-sectional view of another embodiment corresponding to the cross section taken along line D-D of FIG. 6.

As illustrated in FIG. 6, in the ceramic capacitor 100, since the plating layer 133 is formed on both end surfaces of the ceramic body 110 and is formed to completely cover the conductive resin layer 132, the solder s rises up the plating layer 133 during soldering on the substrate 10, and thus the soldering area is increased, so that the ceramic capacitor 100 is stably joined to the circuit pattern 11 of the substrate 10, and the area of the solder s that is connected to the substrate 10 is increased up to the front surface and the rear surface of the ceramic body 110, thereby improving the connection reliability.

Further, as illustrated in FIG. 7, in case of the external electrode 130, since the one-layer structure of a Cu layer comes in direct contact with the solder s, a short current path can be formed. Further, since the conductive resin layer 132 is disposed between the plating layer 133 and the metal layer 131 at the corner part of the ceramic body 110, the difference in thermal expansion coefficient between the solder s and the ceramic body 110 can be absorbed by the conductive resin layer 132, and thus the cracks of the ceramic body 110 can be prevented from occurring.

Further, as illustrated in FIG. 8, since the external electrode 130 has the structure in which the metal layer 131 and the plating layer 133 come in direct contact with each other all over the top and bottom of the both end surfaces of the ceramic body 110, the external electrode 130 can be connected to the internal electrode 120 through the solder s, the plating layer 133, and the metal layer 131, can decrease the electrical resistance, and thus can contribute to the improvement of the ESR.

Further, in another embodiment as illustrated in FIG. 9, in case of the external electrode 130′, since the one-layer structure of a plating layer 133′ connected to the metal layer 131 comes in direct contact with the solder s in the third area m3, in addition to the internal moisture prevention and the corrosion resistance, a short current path can be formed.

In another embodiment that is different from the above-described embodiment, the conductive resin layer 132 is formed on the metal layer 131, and does not come in direct contact with the ceramic body 110. Accordingly, although the conductive resin layer 132 performs the shock absorption function, it may be included in the external electrode 130 in a direction in which the electrical resistance is minimized. Further, the conductive resin layer 132 is formed all over the top and bottom at four corners of the ceramic body 110, and is formed to extend up to the parts of the upper surface and the lower surface connected to the respective corners. Accordingly, the conductive resin layer 132 has the crack prevention function by performing stress distribution and shock absorption function at the corner parts where the stress is concentrated.

Hereinafter, a method for manufacturing a ceramic capacitor according to a first embodiment of the present disclosure will be described.

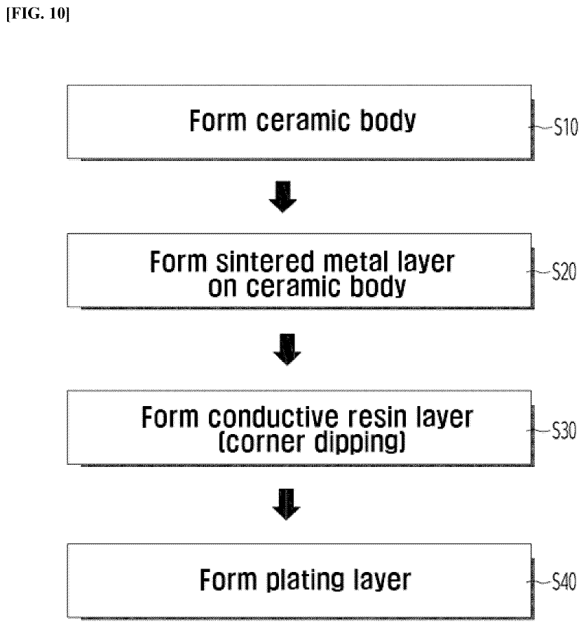

FIG. 10 is a processing diagram showing a method for manufacturing a ceramic capacitor according to an embodiment of the present disclosure, and FIG. 11 is a constitution diagram showing a method for forming a conductive resin layer in a method for manufacturing a ceramic capacitor according to an embodiment of the present disclosure.

As illustrated in FIGS. 10 and 11, a method for manufacturing a ceramic capacitor according to an embodiment of the present disclosure includes: a step (S10) of forming a ceramic body provided with front and rear surfaces facing each other, upper and lower surfaces facing each other, and both end surfaces facing each other, and exposing one end of an internal electrode onto the both end surfaces; a step (S20) of forming a metal layer 131 on the entire both end surfaces of the ceramic body 110 so as to be connected to the internal electrode 120; a step (S30) of forming a conductive resin layer 132 at both-side corners of the both end surfaces of the ceramic body 110, and a step (S40) of forming a plating layer 133.

In the step (S10) of forming the ceramic body, the internal electrode may be formed through printing on an upper surface of a ceramic green sheet on which mixed slurry is thinly coated, and a laminate may be formed by laminating in multiple layers the green sheet on which the internal electrode is printed.

In the step (S20) of forming the metal layer, the metal layer may be formed by applying a paste including a conductive metal or dipping and sintering in a dipping solution including the conductive metal onto the both end surfaces of the ceramic body and from the both end surfaces to a part of the upper and lower surfaces and a part of the front and rear surfaces.

In the step (S30) of forming the conductive resin layer, the conductive resin layer 132 that covers respective corners of the ceramic body 110 and some areas of the upper surface and the lower surface connected to the corners is formed by dipping the corners of the ceramic body 110 on which the metal layer 131 is formed in Ag epoxy resin solution L.

As an example, the conductive resin layer 132 that is made of Ag epoxy resin is formed even at the other side corner of the ceramic body 110 in a manner that the entire one-side corner of the ceramic body 110 is dipped in and then taken out of the Ag epoxy resin solution through an insertion port p of a support jig G, the conductive resin layer 132 is formed on the metal layer 131 of the taken-out one-side corner, and then the entire other-side corner that is an opposite side is dipped in and then taken out of the Ag epoxy resin solution L through the insertion port p of the supporting jig G.

In the step (S30) of forming the conductive resin layer, the application thickness of the conductive resin layer 132 can be controlled by adjusting dipping process variables. As an example, the entire one-side corner of the ceramic body 110 is dipped in the Ag epoxy resin solution L twice, and the application thickness of the conductive resin layer is adjusted to a desired thickness by adjusting a first dipping time and a second dipping time, so that the conductive resin layer can be uniformly applied. The thickness of the conductive resin layer 132 may be about 10 μm to 20 μm, and the thickness may become gradually thinner toward the edge at the corner part. If the thickness of the conductive resin layer 132 is equal to or smaller than about 10 μm, the application thickness is unable to be uniform, the electrical conductivity is decreased through reduction of the density of the Ag layer, and it is difficult to expect the crack prevention effect. In case of the thickness of the conductive resin layer that is equal to or smaller than 20 μm, it is possible to secure a high shock absorption function and excellent reliability.

In the step (S30) of forming the conductive resin layer, curing may be performed below 300 degrees after the dipping. The conductive resin layer 132 has the effect of crack prevention by forming a buffer layer against an external stress through giving of ductility to the external electrode.

The step (S40) of forming a plating layer is performed after the step (S30) of forming the conductive resin layer. In the step (S40) of forming the plating layer, the plating layer 133, which comes in direct contact with the metal layer 131 all over the top and bottom, and completely covers the conductive resin layer 132, is formed on both end surfaces of the ceramic body 110.

Further, in the step (S40) of forming the plating layer, the plating layer 133′, which comes in direct contact with the metal layer 131 all over the top and bottom, and completely covers the conductive resin layer 132 and the metal layer 131, is formed on both end surfaces of the ceramic body 110. The plating layer 133 or 133′ may have a one-layer structure of the Ni plating layer, or a two-layer structure of the Ni plating layer and Sn plating layer. The plating layer 133 or 133′ may be formed in an electroplating process.

In the embodiments of the present disclosure manufactured by the above-described method, the cracks are prevented from occurring even if the corner part is under a lot of stress due to the difference in thermal expansion coefficient when the ceramic body is mounted on the substrate since the conductive resin layer 132 is formed all over the top and bottom of the corner areas of the ceramic body that experience the most stress, and thus the shock absorption function is provided.

Further, the ESR can be improved through shortening of the current path and reduction of the electrical resistance since the plating layer 133 or 133′ comes in direct contact with the metal layer 131 all over the top and bottom of the corner areas of the ceramic body 110.

The ceramic capacitor of the above-described embodiments may be used as the MLCC that is applied to various items, such as a smartphone, a PC, a TV, an electric vehicle, and the like.

The above explanation of the present disclosure is merely for exemplary explanation of the technical idea of the present disclosure, and it can be understood by those of ordinary skill in the art to which the present disclosure pertains that various corrections and modifications thereof will be possible in a range that does not deviate from the essential characteristics of the present disclosure. Accordingly, it should be understood that the embodiments disclosed in the present disclosure are not to limit the technical idea of the present disclosure, but to explain the same, and thus the scope of the technical idea of the present disclosure is not limited by such embodiments. The scope of the present disclosure should be interpreted by the appended claims to be described later, and all technical ideas in the equivalent range should be interpreted as being included in the scope of the present disclosure.

1. A ceramic capacitor comprising:
a ceramic body formed in a hexahedron shape, including a plurality of dielectric layers and at least a pair of internal electrodes disposed to face each other with the dielectric layers interposed therebetween, and including both end surfaces from which the internal electrodes are exposed, a lower surface that is a mount surface mounted on a substrate, an upper surface facing the lower surface, and a front surface and a rear surface connecting the upper surface and the lower surface together and facing each other; and
external electrodes disposed on the both end surfaces of the ceramic body so as to be electrically connected to the internal electrodes,
wherein the external electrode includes:
a metal layer formed throughout the end surfaces of the ceramic body so as to be connected to the internal electrode; and
a conductive resin layer formed at both-side corners of the end surfaces of the ceramic body.

2. The ceramic capacitor of claim 1, wherein the metal layer is formed to extend from the end surfaces of the ceramic body to the upper and lower surfaces and the front and rear surfaces of the ceramic body.

3. The ceramic capacitor of claim 1, wherein the metal layer has a center part between the both-side corners on the end surfaces of the ceramic body, which is exposed without being covered by the conductive resin layer.

4. The ceramic capacitor of claim 2, wherein the conductive resin layer is formed on the metal layer.

5. The ceramic capacitor of claim 1, wherein the conductive resin layer is in a shape that covers the entire top and bottom of the both-side corners of the end surfaces of the ceramic body.

6. The ceramic capacitor of claim 1, wherein the conductive resin layer is in a shape that covers up to some areas of the upper surface and the lower surface connected to the respective corners.

7. The ceramic capacitor of claim 1, wherein the external electrode further comprises a plating layer.

8. The ceramic capacitor of claim 7, wherein the plating layer comes in direct contact with the metal layer all over the top and bottom on the end surfaces of the ceramic body.

9. The ceramic capacitor of claim 7, wherein the plating layer is in a shape that completely covers the conductive resin layer.

10. The ceramic capacitor of claim 7, wherein the plating layer comprises a first area that comes in contact with the conductive resin layer and a second area that comes in contact with the metal layer on the upper and lower surfaces and the front and rear surfaces of the ceramic body.

11. The ceramic capacitor of claim 7, wherein the plating layer is formed on the conductive resin layer and the metal layer on the upper and lower surfaces and the front and rear surfaces of the ceramic body, and exposes a part of the metal layer to outside.

12. The ceramic capacitor of claim 7, wherein the plating layer comprises a first area that comes in contact with the conductive resin layer, a second area that comes in contact with the metal layer, and a third area that comes in contact with the ceramic body on the upper and lower surfaces and the front and rear surfaces of the ceramic body.

13. The ceramic capacitor of claim 7, wherein the plating layer has a one-layer structure of an Ni plating layer or a two-layer structure of a Ni plating layer and a Sn plating layer.

14. The ceramic capacitor of claim 1, wherein the metal layer comprises Cu, and the conductive resin layer is made of Ag epoxy resin.

15. A method for manufacturing a ceramic capacitor comprising:
a step of forming a ceramic body provided with front and rear surfaces facing each other, upper and lower surfaces facing each other, and both end surfaces facing each other, and exposing internal electrodes onto the both end surfaces;
a step of forming a metal layer on the entire both end surfaces of the ceramic body so as to be connected to the internal electrodes; and
a step of forming a conductive resin layer at both-side corners of the both end surfaces of the ceramic body.

16. The method of claim 15, wherein the step of forming the metal layer forms the metal layer by applying a paste including a conductive metal or dipping and sintering in a dipping solution including the conductive metal onto the both end surfaces of the ceramic body and from the both end surfaces to a portion of the upper and lower surfaces and a portion of the front and rear surfaces.

17. The method of claim 15, wherein the step of forming the conductive resin layer forms the conductive resin layer that covers respective corners of the ceramic body and some areas of the upper surface and the lower surface connected to the corners by dipping the corners of the ceramic body on which the metal layer is formed in Ag epoxy resin solution.

18. The method of claim 15, further comprising a step of forming a plating layer which comes in direct contact with the metal layer over the entire top and bottom on the both end surfaces of the ceramic body, and which completely covers the conductive resin layer after the step of forming the conductive resin layer.
